(19) United States
(12) Patent Application Publication
(10) Pub. No.: US 2019/0287076 A1
(43) Pub. Date: Sep. 19, 2019

(54) Meeting Planning Software Application

(71) Applicant: Round-Abouts Group Limited, Newark Nottinghamshire (GB)

(72) Inventors: Estera Sutton, Newark Nottinghamshire (GB); Anthony Sutton, Newark Nottinghamshire (GB); Andrew Thompson, Newark Nottinghamshire (GB)

(21) Appl. No.: 16/317,784

(22) PCT Filed: Jul. 11, 2017
(86) PCT No.: PCT/GB2017/052024

§ 371 Date: Jan. 14, 2019

(30) Foreign Application Priority Data
Jul. 13, 2016 (GB) 1612199.8
Sep. 5, 2016 (GB) 1614988.2

(51) Int. Cl. G06Q 10/10; H04W 4/029

(52) U.S. Cl. CPC G06Q 10/1095; H04L 67/10; H04W 4/029

(57) ABSTRACT

A tool for arranging a meeting comprising a computing device having processing means, memory means and user interface means, the tool being operable to record details of a user and a logged event such as detail of a user's future locations and to compare the logged events of the user with those of another user in order to determine an overlap which is a future time when the compared users will be located close to one another and if an overlap is determined, to provide an overlap notification to warn the user of the overlap via the user interface.

### CROSS-REFERENCE TO RELATED APPLICATIONS

The present application claims priority to PCT International Patent Application No. PCT/GB2017/052024, filed Jul. 11, 2017, Great Britain Patent Application No. 1614988.2 filed on Sep. 5, 2016, and Great Britain Patent Application No. 1612199.8 filed on Jul. 13, 2016 the disclosure of which are each incorporated herein by reference.

### STATEMENT RE: FEDERALLY SPONSORED RESEARCH/DEVELOPMENT

Not Applicable

### BACKGROUND

This invention relates to a tool to help coordinate meetings.

### TECHNICAL BACKGROUND

In the prior art, software applications, typically for use on a handheld device such as a smartphone or tablet, are available and which let a user know where their contacts are located. This is adequate for coincidental meetings if you happen to be in the same place at the same time, but requires communication and planning to ensure a meeting takes place.

Existing software, apps for handheld devices and websites are focused on delivering real-time—i.e. here and now—solutions which can only provide notifications of where your contacts are at that specific point in time, allowing only for coincidental meetings if both contacts proactively realize that they happen to be in the same location at the same time and they have a way to get in touch.

### BRIEF SUMMARY

### Summary of the Invention

In a first aspect, the invention provides a tool for arranging a meeting comprising a computing device having processing means, memory means and user interface means, the tool being operable to record details of a user and a logged event such as detail of a user's future locations and to compare the logged events of the user with those of another user in order to determine an overlap which is a future time when the compared users will be located close to one another and if an overlap is determined, to provide an overlap notification to warn the user of the overlap via the user interface.

This invention is focused on the future thus letting a user know in advance if travel plans overlap with those of any relevant contacts and then giving the user an option to get in touch; meaning that the user's meetings need no longer be left to chance.

This invention provides a forward/future looking solution which allows for advanced, effective planning rather than an opportunistic/coincidental event which is aimed at achieving a higher ‘success rate’ (whereby success can be considered as a meeting/coming together). The only way that this future looking/forward planning can currently be achieved relies on a very significant, inefficient, non-automated and proactive approach by an individual who would need to use some form of manual, direct communication or messaging to each contact or group of contacts whom they would be interested in meeting with.

The invention makes it easier to identify when relevant contacts are going to be in the same place, at the same time, in the future, and provides proactive notification of such an event along with a user friendly communication platform that puts the relevant contacts in direct communication.

This invention provides a far more efficient and effective solution, requiring minimal effort by the user who merely needs to log the details [typically relevant location, relevant date, contact group(s) of interest] of their upcoming/future travel arrangements (to create a “logged event”), with the software/app for a handheld device then looking for relevant overlaps with the future plans of their chosen contact groups.

This solution is achieved by using a logic driven, future focused platform that identifies when a user will be in the same relevant location* or at any relevant event/activity* on the same relevant date* as any relevant contact* and provides a proactive notification (i.e. no actions required of the user) of such an occurrence. Furthermore, this invention provides a relevant communication interface* to allow the user to communicate with the relevant contact*.

A key differentiator of the invention, is the forward looking nature—as opposed to prior art software applications which are real time focused.

By being forward/future focused, this allows for advanced, effective planning rather than an opportunistic/coincidental event—ultimately aimed at achieving a higher ‘success rate’ (whereby success is effectively a meeting/coming together).

This ‘forward looking’ element is underpinned by a significant amount of logic processing, which in turn ensures that only relevant future events are identified to a user.

In a second aspect, the invention provides a method of arranging a meeting using a computing device having processing means, memory means and user interface means, the method steps comprising, recording details of a user and a logged event such as detail of a user's future locations, comparing the logged events of the user with those of another user in order to determine an overlap which is a future time when the compared users will be located close to one another and if an overlap is determined, providing an overlap notification to warn the user of the overlap via the user interface.

In a third aspect, the invention provides a computer program which when executed on a handheld device having processing means, memory means and user interface means carries out the steps of the method of the second aspect.

In a fourth aspect, the invention provides a computer program distributed and executing between a handheld device a server, the handheld device and server being connected over a network and the combination having processing means, memory means and user interface means and being arranged to carry out the of the method of the second aspect. This may for example be a cloud-based implementation with multiple, distributed remote servers.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic block diagram of the hardware components;

FIG. 2 is a schematic block diagram of the user experience flow;

FIG. 3 is an example login page in the app;

FIG. 4 is an example registration page in the app;

FIG. 5 is an example profile page in the app;

FIG. 6 is an example event input page in the app;

FIG. 7 is an example logged event page in the app;

FIG. 8 is an example overlap notification page in the app;

FIG. 9 is an example second overlap notification page in the app;

FIG. 10 is an example accepted overlap page in the app; and

FIG. 11 is an example messaging page in the app.

### DETAILED DESCRIPTION

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

In the present description, the following definitions are intended:

App for a handheld device: means a software application such as that downloadable from the Apple App Store or Android Play Store.

Logged Event: means an event a user has created within the app for a handheld device, website or software which includes the details of each of the logic elements [relevant location, relevant date(s) and relevant contacts] that are required to look for commonality amongst relevant contacts.

Relevant Location: means the specific location which has been input by a user during the process of “logging an event” along with any other locations or areas which fall within a set radius (as defined/chosen by the user) of the specific location.

Relevant Event/activity: means a specific event/activity and/or event/activity venue input by a user during the process of “logging an event” along with any other locations or areas which fall within a set radius (as defined/chosen by the user) of the specific event or event venue.

Relevant Date: means the date, dates, date range and/or time, times or time range which applies to the logged event i.e. the date(s) or time(s) that a user has identified they will be at the relevant location or event.

Relevant Contact: means any contact or contacts who have been identified/selected by a user as being within a sub-set of their entire contacts list, with said sub-set having been chosen as a relevant sub-set within the “logged event”—whereby a sub-set is typically defined according to the relationship type that the user has assigned to a contact.

Communication Interface: means a set of options provided within this platform that allows for the exchange of communications between a user and any relevant contacts—and which references the details of an appropriate logged event such that it is clear to the user which logged event the communication refers to.

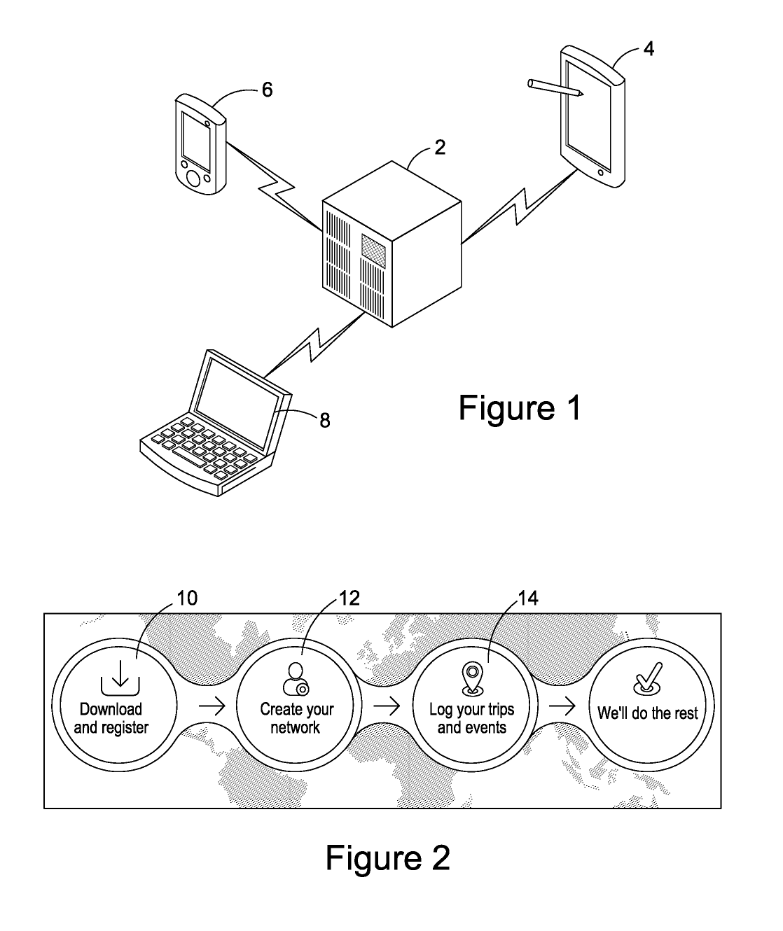

With reference to FIG. 1, a server 2 coordinates information from a plurality of user devices such as a tablet 4, a smartphone 6 or a PC/laptop 8. The users are connected remotely to the server 2 via a network such as a LAN or the Internet. The user devices may interact with the server 2 using a web browser or via a dedicated software application. Optionally, the server 2 may be omitted and the system may operate in a peer-2-peer mode.

With reference to FIG. 2, the primary user steps are shown diagrammatically and are described in more detail below.

Download and Register (Step 10)

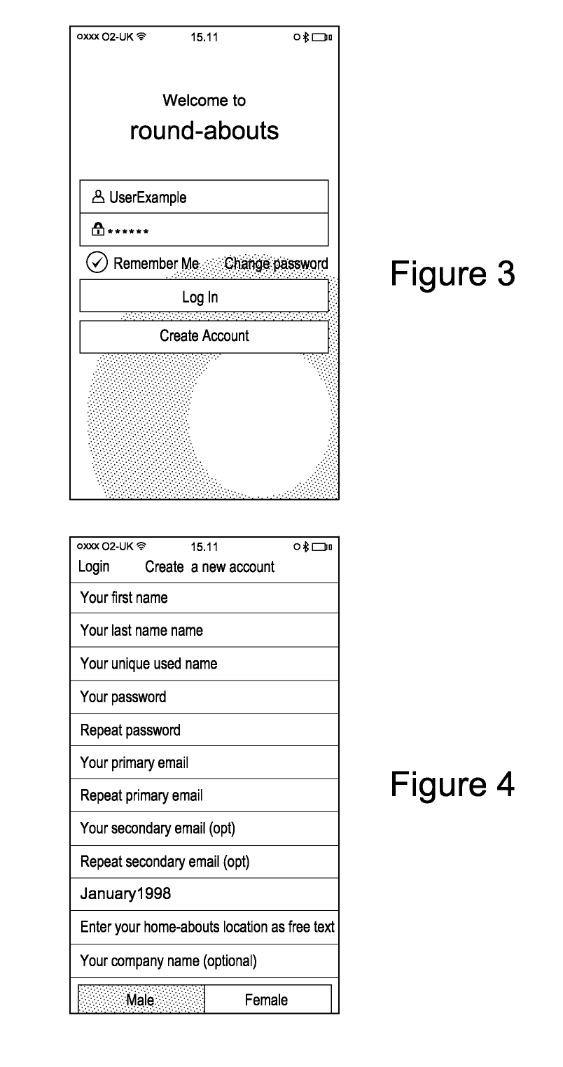

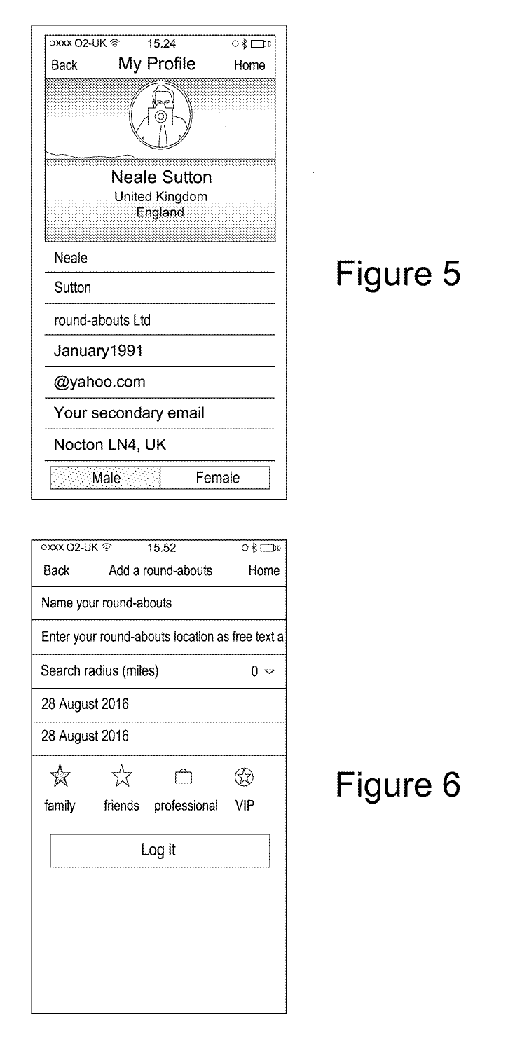

Download the application to your smartphone, tablet or other computing device with user input and display means, and register your details (FIGS. 3 and 4) to create a profile (FIG. 5) which can be compared with other users.

Create Your Network (Step 12)

This feature allows the user to categorize their contacts into various groups—typically there will be 4 default groupings:
Friends
Family
Business Contacts
VIP
   (with the user eventually able to also create their own groupings),

These groupings typically form a key element of the logic processing,

The contacts list may be linked to a user's phone Address Book—which is hosted within the Software application interface to allow for easy identification (via set icons next to the contact name) of:
Contacts in the address book which do not have the Software application downloaded—against these contacts, are shown with an easy click icon that sends an invitation from the user to join/download the tool by completing step 10.
Contacts in the address book who the user has previously invited but are yet to download the Software application (i.e. a pending status)
Contacts who are in the address book who have downloaded the Software application but whom the user has not yet categorized (with a Software application/icon/button inviting you to categorize them)
Contacts whom the user has assigned a relationship/categorization value to—note: this subset of contacts are listed in the Contacts page of the Software application as opposed to the Address Book (the differentiator being that those contacts in the address book require further action before they will be included in the tool's searches/network.

Log Your Trips and Events (Step 14)

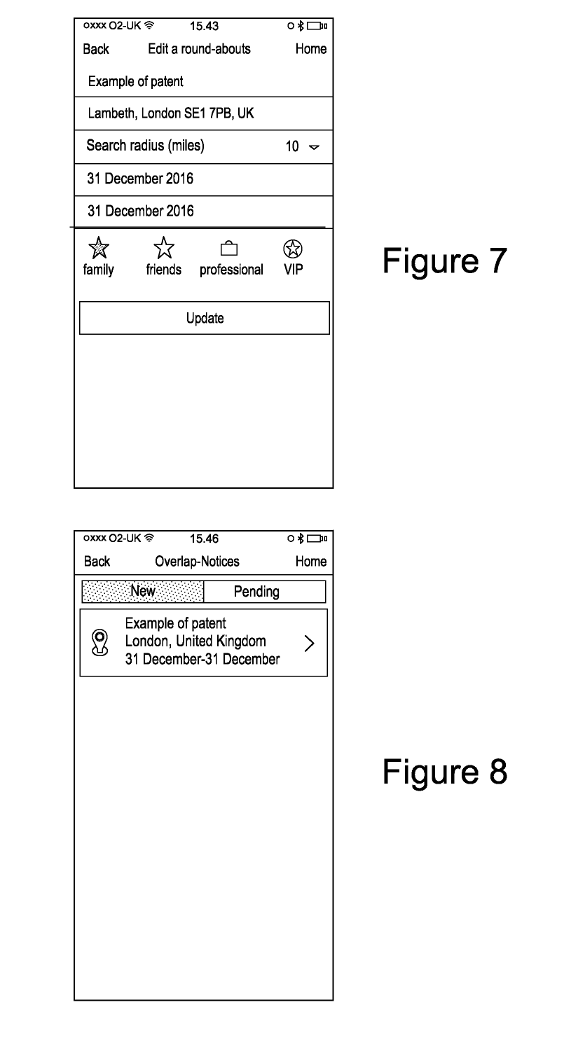

Upon logging your event (FIGS. 6 and 7), the user is required to complete a number of fields—these typically being:
Location
The Date Range during which you will be at that location
The Contact groups/relationship grouping(s) that you wish to look for an overlapping event/location with
Whether you wish for your username to be Public or Private (relevant to the “Overlaps Notice—see below),

In particular, FIG. 7 shows a Logged Event with all fields completed (right) including Event [round-abouts] Name—“Example for patent”, Relevant Location—“Lambeth, London”, the Search/Area Radius—“10 miles”, the Relevant Date Range—“31st December 2016 to 31st December 2016” and the Relevant Contact Group sub-sets that the user is looking for commonality/an Overlap with—“Family and VIP”.

Based on the information collected in the logging of an event, the background logic processing engine in the server 2 or on the device itself then gets to work, looking for a set of commonalities within User A's relevant contacts (i.e. the selected groups)—by identifying whether any of User A's contacts from the selected groups will be in the same place at the same time as User A. (Note: with respect to time, there typically needs to be only 1 day of overlap between date ranges to generate a positive result).

If this generates positive results there is a further step carried out before an overlap notification is generated: User A must be within a relevant Contact Grouping for the corresponding overlap—i.e. when a User B was logging events, he must have selected to look for overlaps with the Contact Grouping that he has assigned User A to.

Please see below chart to explain a typical logic match required to generate an Overlap Notification

| Field | User A | User B | Field |
|---|---|---|---|
| Location | Y | Y | Location |
| Date | Y | Y | Date |
| User B in relevant | Y | Y | User A in relevant |
| (selected) Group? | | | (selected) Group? |

In the instance that ALL searched fields generate a POSITIVE return, an Overlap Notification is generated—see below.

In the instance that ANY of the searched fields generates a ZERO/NEGATIVE return, no Overlap Notification is generated for either user.

Overlap Notifications

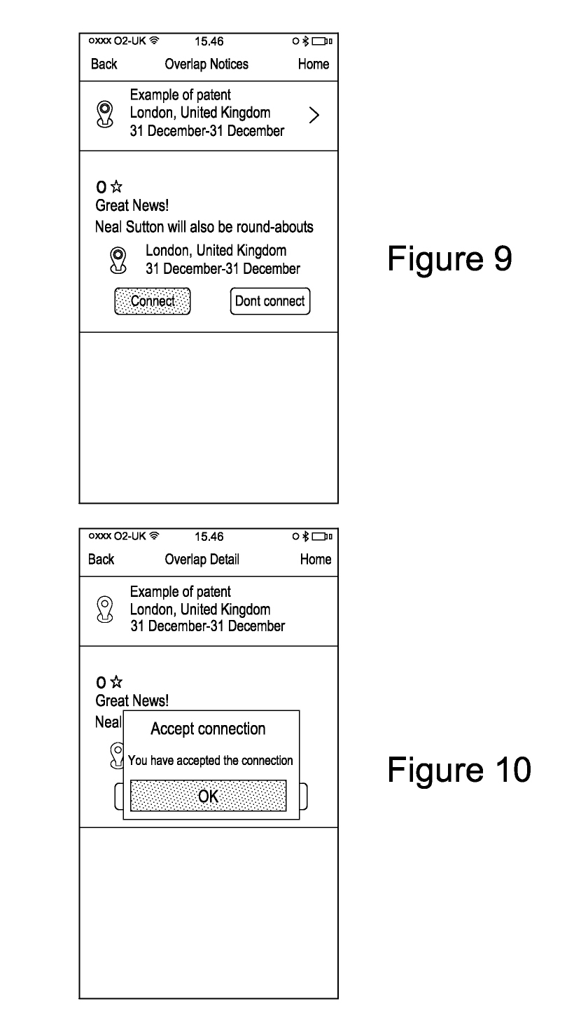

Following a positive result across all relevant fields, both User A and User B will receive an Overlap Notification (FIGS. 8 and 9): FIG. 8 shows a first stage Overlap Notification and FIG. 9 shows an expanded Overlap Notification which contains full details of the Overlap and the relevant Contact.

Dependent on the Privacy Settings that were selected during the logging process (Step 14), the notification may read as follows:

If the Contact is selected Public—

“Great News! One of your contacts (User B) will also be round-abouts [location] on [date]” There is then an option to “Make a Connection” or “Don't Connect Me”.

Also shown are icons to highlight the Contact Grouping relevant to the Overlapping Contact (to allow for easy identification of whether they are a Friend, Family, Business Contact or VIP member).

If the Contact is selected as Private—

“Great News! One of your contacts will also be round-abouts [location] on [date]” There is then an option to “Make a Connection” or “Don't Connect Me”.

Again, even in the event of the Contact having selected a private setting, also shown are icons to highlight the Contact Grouping relevant to the Overlapping Contact (to allow for easy identification of whether they are a Friend, Family, Business Contact or VIP member).

The user is then presented with an option to connect to the other user and FIG. 10 shows a user accepting the Overlapping Connection.

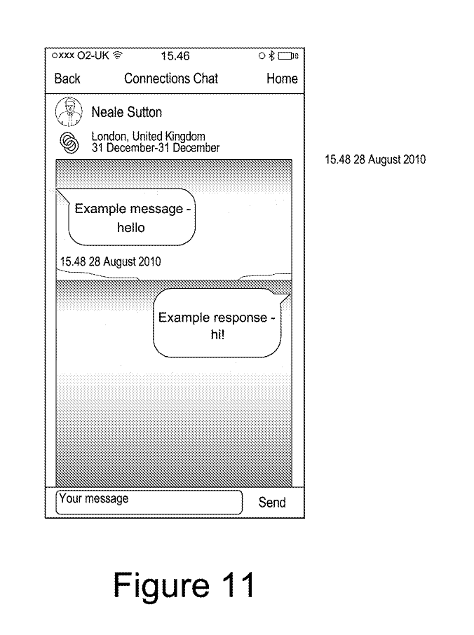

Upon BOTH contacts clicking “Make a Connection”—they progress to the Connection HUB (FIG. 11) which is typically a “Chat” or “Messaging” page which contains clear reference to the details of the Overlapping Event and allows for the users to make arrangements to meet at their overlapping event/location.

Upon EITHER contact clicking “Don't Connect Me” or taking no action, the Overlap Notification remains in a pending state.

The software application is aimed at both social users and professional users—the use case for Professional Users being explained below:

If you are visiting a forthcoming conference or exhibition, it is likely that many contacts you wish to meet will be attending as well. Conventionally you will need to email each person to find out if they will be attending and then try to arrange to meet.

The tool does all of this work for you: a user simply logs their attendance at an event and the tool will let the user know how many members of their network are also going to be attending via an Overlap Notice. Then the user just chooses whether to make a connection and the tool puts them in touch.

For a professional user, there is the option to include their Employer/Company Details on their profile—in the instance that they have opted to do this, when an Overlap Notification is generated with someone in their Business Contact Group, the Overlap Notification may be as follows:

“Great News! One of your contacts (User X) from [Company Name] will also be round-abouts [location] on [date]” There is then an option to “Make a Connection” or “Don't Connect Me”.

Location Search

The location search within the logic is typically based on a radial search from the user's logged location, with the user having the option to select the radius—ranging from an “exact only” location to a radial search spanning X miles from the inputted location (where X is a figure selected by the user for each event). This will then allow the user to identify very focused “overlaps” e.g. which of their contacts are going to be in a specific bar/restaurant on a specific night out or alternatively have a much wider search which can identify ‘city wide’ overlaps for example.

The tool may also record a home location which remains the user's default location when not travelling. The option is then available to choose which contact groups are of interest when the user is located in this home location, so that arrangements may be made if any contacts of interest are going to be in the home location too.

1. A tool for arranging a meeting comprising a computing device having processing means, memory means and user interface means, the tool being operable to record details of a user and a logged event such as detail of a user's future locations and to compare the logged events of the user with those of another user in order to determine an overlap which is a future time when the compared users will be located close to one another and if an overlap is determined, to provide an overlap notification to warn the user of the overlap via the user interface.

5. A tool as claimed in claim 1 wherein the comparison is carried out by looking for future commonality across a plurality of parameters within the logged events of the users who have indicated a connection during recording of their user details and wherein the notification is provided to each user only if there is full commonality across each parameter thereby to ensure complete relevance to the user.

2. A tool as claimed in claim 1, wherein the computing device is a handheld device such as a smartphone or tablet running a dedicated app, and the user is required to register to create an account or the user may use the registration data as provided to other services, such as Facebook or LinkedIn in order to create an account.

3. A tool as claimed in claim 1, that runs on a server and can be accessed by the user via a website or webpage, with the user being required to register to create an account or the user may use the registration data as provided to other services, such as Facebook or LinkedIn in order to create an account.

4. A tool as claimed in claim 1, wherein as part of the registration process, predetermined user data is collected in order to create a unique account for the user, with predetermined elements of such data then being used and displayed by the tool during the overlap notification process.

6. A tool as claimed in any of claim 5, wherein the parameters across which future commonality which is sought for a logged event includes any of the Relevant Location which is either a specific location or a wider area within a user defined radius of a specific location, and Relevant Date which is either a specific date, date range, time or time range as defined by the user.

7. A tool as claimed in any of claim 5, which is operable to allow a user to re-open and amend the parameters of a logged event, and to carry out a further comparison and report any appropriate commonality based on the amended parameters.

8. A tool as claimed in claim 5, wherein commonality is only sought across “Relevant Contacts” whereby the user is able to categorize their linked contacts amongst defined sub-sets or relationship types and only those sub-sets selected by the user are included within the commonality comparison.

11. A tool as claimed in claim 1, wherein the overlap notification contains relevant information of the contact with which they have a commonality—such as their name, their location and the date, date range, time or time range during which they will be at the common location.

9. A tool as claimed in claim 8, which is operable to allow a user, upon receiving an overlap notification to choose whether to proceed and make a connection with the relevant contact or to ignore the overlap.

10. A tool as claimed in claim 9, wherein the tool provides a messaging platform between users once they have both made a connection to each other.

12. A tool as claimed in claim 1, wherein if an overlap notification is generated with another user who is categorized as being within a “Professional” contact group sub-set, additional information regarding that user is provided in the notification to enhance the relevance of the notification such as the Company/Employer details that were collected during the registration process of that user.

13. A tool as claimed in claim 1, which is operable to allow direct messaging or communication between users who have received/experienced an overlap notification, and said messaging platform containing reference to the overlapping event in order to ensure relevance.

14. A tool as claimed in claim 1, wherein when an overlap notification has been made, the tool is operable to allow the overlapping users to invite other users to the overlapping event even if they have not also logged an event with commonality.

15. A tool as claimed in claim 1, operable to record an archive of a user's logged events and allow the user to link other media such as photos, videos or messages to those archived events and to download or view them after the event has taken place.

16. A method of arranging a meeting using a computing device having processing means, memory means and user interface means, the method steps comprising, recording details of a user and a logged event such as detail of a user's future locations, comparing the logged events of the user with those of another user in order to determine an overlap which is a future time when the compared users will be located close to one another and if an overlap is determined, providing an overlap notification to warn the user of the overlap via the user interface.

17. A computer program which when executed on a handheld device having processing means, memory means and user interface means carries out the steps of claim 16.

18. A computer program distributed and executing between a handheld device a server, the handheld device and server being connected over a network and the combination having processing means, memory means and user interface means and being arranged to carry out the steps of claim 16.

19. A computer program as claimed in claim 18 which is executable on the handheld device.

20. A computer program as claimed in claim 18 which is executable on the server.
